(19) United States
(12) Patent Application Publication
(10) Pub. No.: US 2017/0053595 A1
(43) Pub. Date: Feb. 23, 2017

(54) PIXEL CIRCUIT

(71) Applicant: Polyera Taiwan Corporation, Zhubei (TW)

(72) Inventors: PO-TSUN LIU, Hsinchu (TW); GUANG-TING ZHENG, Hsinchu (TW); CHENG-YU TSAI, Kaohsiung (TW); HSING-HUNG HSIEH, Zhubei (TW); CHUNG-CHIN HSIAO, Zhubei (TW)

(21) Appl. No.: 14/828,491

(22) Filed: Aug. 17, 2015

(51) Int. Cl. G09G 3/32; G09G 3/20

(52) U.S. Cl. CPC G09G 3/3241; G09G 3/3258; G09G 3/3291; G09G 3/2003; G09G 2300/0426; G09G 2300/0842; G09G 2310/0256; G09G 2320/043

(57) ABSTRACT

A pixel circuit includes first to third switches, a transistor, a light emitting diode, and first and second capacitors. The first switch has its control end coupled to a first scan line and its first end for receiving a data signal. The second switch has its control end coupled to a second scan line and its third end for receiving a power supply voltage. The transistor has its control end coupled to the second end and its fifth end coupled to the fourth end. The third switch has its control end coupled to a third scan line and its eighth end coupled to the sixth end. the light emitting diode has its anode and cathode coupled to the eighth end and a reference voltage level, respectively. The first and second capacitors are coupled between the second end and seventh end and between the seventh end and reference voltage level, respectively.

### FIELD OF THE INVENTION

The present invention relates to display technology, and more particularly to a pixel circuit of an organic light emitting diode display.

### BACKGROUND OF THE INVENTION

Compared with liquid crystal display (LCD), organic light emitting diode (OLED) display is extensively developed in industries due to advantages, such as high contrast, wide viewing angle, no need of a backlight module thereby reducing thickness of the display, low power consumption and low cost, etc. Thus, organic light emitting diode display has become one of the mainstreams in the current display market.

However, organic light emitting diode displays still have drawbacks. For example, threshold voltage of driving transistors in a pixel circuit and. crossing voltage of organic light emitting diodes in an organic light emitting diode display may increase after long-term usage. Therefore, if providing the same data voltage level to pixel circuits, the actual current flowing through the organic light emitting diodes and subsequently the luminance of the organic light emitting diode would eventually reduce.

### SUMMARY OF THE INVENTION

Therefore, through a proper configuration, the present invention provides a pixel circuit capable of effectively compensating the variations in threshold voltage of driving transistors and crossing voltage of organic light emitting diodes; and consequently, dimming of organic light emitting diodes after long-tem usage can be prevented.

The present invention provides a pixel circuit, which includes a first switch, a second switch, an N-type transistor (functioned as a driving transistor), a third switch, an organic light emitting diode, a first capacitor and a second capacitor. The first switch has a first control end, a first end and a second end. The first switch is configured to have the first control end electrically coupled to a first scan line and the first end for receiving a data signal. The second switch has a second control end, a third end and a fourth end. The second switch is configured to have the second control end electrically coupled to a second scan tine and the third end for receiving a power supply voltage. The N-type transistor has a third control end, a fifth end and a sixth end. The N-type transistor is configured to have the third control end electrically coupled to the second end and the fifth end electrically coupled to the fourth end. The third switch has a fourth control end, a seventh end and an eighth end. The third switch is configured to have the fourth control end electrically coupled to a third scan line and the eighth end electrically coupled to the sixth end. The organic light emitting diode has an anode and a cathode. The organic light emitting diode is configured to have its anode electrically coupled to the eighth end and the cathode electrically coupled to a first reference voltage level. The first capacitor is electrically coupled between the second end and the seventh end. The second capacitor is electrically coupled between the seventh end and the first reference voltage level.

In one embodiment, the first scan line, the second scan line and the third scan line are configured to deliver a first scan signal, a second scan signal and a third scan signal, respectively. During a reset period, the power supply voltage has a first voltage level, the first scan signal and the second scan signal are configured to turn on the first switch and the second switch respectively, the third scan signal is configured to turn off the third switch, and the data signal has a second reference voltage level. During a compensation period, the power supply voltage has a second voltage level, the first scan signal, the second scan signal and the third scan signal are configured to turn on the first switch, the second switch and the third switch respectively, and the data signal has the second reference voltage level, During a data writing period, the power supply voltage has the second Voltage level, the first scan signal is configured to turn on the first switch, the second scan signal and the third scan signal are configured to turn off the second switch and the third switch respectively, and the data signal has a data voltage level. During a light-emitting period, the power supply voltage has the second voltage level, the first scan signal is configured to turn off the first switch, the second scan signal and the third scan signal are configured to turn on the second switch and the third switch respectively, and the data signal has the second reference voltage level. The reset period occurs prior to the compensation period, the compensation period occurs prior to the data writing period, and the data writing period occurs prior to the light-emitting period. The first voltage level is lower than the first reference voltage level, the second voltage level is higher than the first reference voltage level, and the data voltage level is higher than the second reference voltage level.

In one embodiment, the first scan line is configured to deliver a first scan signal and both of the second scan line and the third scan line are configured to deliver a second scan signal. During a reset period, the power supply voltage has a first voltage level, the first scan signal is configured to turn on the first switch, the second scan signal is configured to turn on the second switch and the third switch, and the data signal has a second reference voltage level. During a compensation period, the power supply voltage has a second voltage level, the first scan signal is configured to turn on the first switch, the second scan signal is configured to turn on the second switch and the third switch, and the data signal has the second reference voltage level. During a data writing period, the power supply voltage has the second voltage level, the first scan signal is configured to turn on the first switch, the second scan signal is configured to turn off the second switch and the third switch, and the data signal has a data voltage level. During a light-emitting period, the power supply voltage has the second voltage level, the first scan signal is configured to turn off the first switch, the second scan signal is configured to turn on the second switch and the third switch, and the data signal has the second reference voltage level. The reset period occurs prior to the compensation period, the compensation period occurs prior to the data writing period, and the data writing period occurs prior to the light-emitting period. The first voltage level is lower than the first reference voltage level, the second voltage level is higher than the first reference voltage level, and the data voltage level is higher than the second reference voltage level, p In sum, by configuring the first switch, the second switch and the third switch to be turned ON or OFF during the reset period, the compensation period, the data writing period T3 and the light-emitting period, respectively, the current flowing through the N-type transistor is independent of the threshold voltage of the N-type transistor and the crossing voltage of the organic light emitting diodes in the pixel circuit of the present invention; and consequently, a compensation effect is achieved.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

The present invention will become more readily apparent to those ordinarily skilled in the art after reviewing the following detailed description and accompanying drawings, in which:

FIG. 1 is a schematic diagram of a pixel circuit in accordance with the first embodiment of the present invention;

FIG. 2 is a chronological sequence of related signals for operating the pixel circuit of FIG. 1 in accordance with an embodiment of the present invention; and

FIG. 3 is a schematic diagram of a pixel circuit in accordance with the second embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

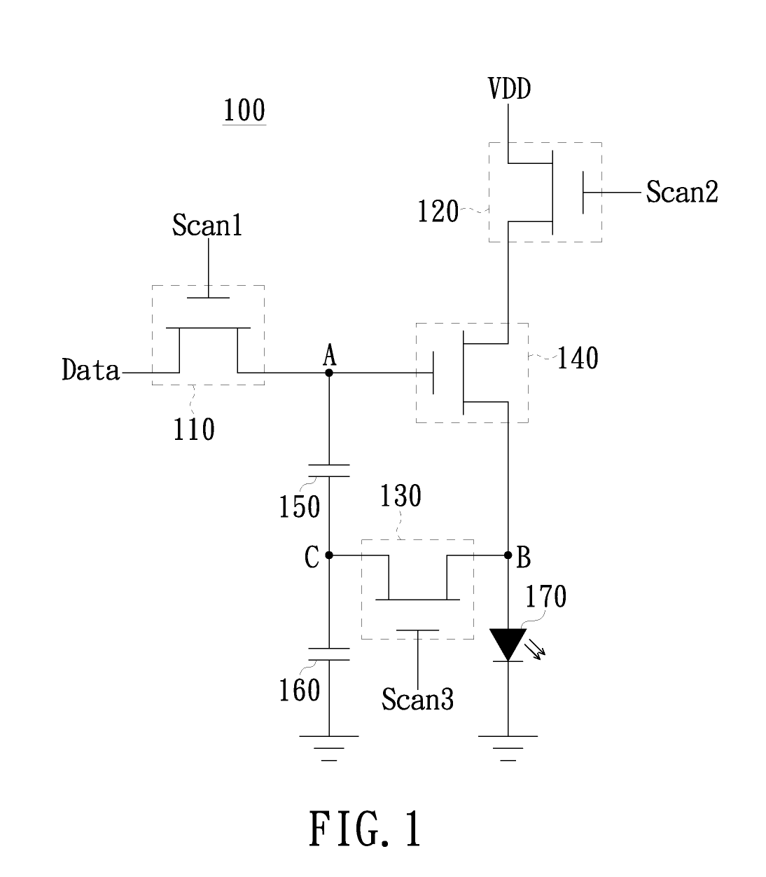

Please refer to FIG. 1, which is a schematic pixel circuit diagram in accordance with the first embodiment of the present invention, As shown in FIG. 1 the pixel circuit 100 in the present embodiment includes a first switch 110, a second switch 120, a third switch an N-type transistor 140 (functioned as a driving transistor in one embodiment), a first capacitor 150, a second capacitor 160 and an organic light emitting diode (OLED) 170, The first switch 110 has a first control end, a first end and a second end. The first switch 110 is configured to have the first control end electrically coupled to a first scan line (not shown) and the first end for receiving a data signal Data. The second switch 120 has a second control end, a third end and a fourth end. The second switch 120 is configured to have the second control end electrically coupled to a second scan line not shown) and the third end for receiving a power supply voltage VDD. The N-type transistor 140 has a third control end, a fifth end and a sixth end. The N-type transistor 140 is configured to have the third control end electrically coupled to the second end and the fifth end electrically coupled to the fourth end. The third switch 130 has a fourth control end, a seventh end and an eighth end. The third switch 130 is configured to have the fourth control end electrically coupled to a third scan line (not shown) and the eighth end electrically coupled to the sixth end. The organic light emitting diode 170 is configured to have the anode electrically coupled to the eighth end and its cathode electrically coupled to a first reference voltage level. The first capacitor 150 is electrically coupled between the second end and the seventh end. The second capacitor 160 is electrically coupled between the seventh end and the first reference voltage level. In addition, the pixel circuit 100 of FIG. 1 further shows a first node A, a second node B and a third node C.

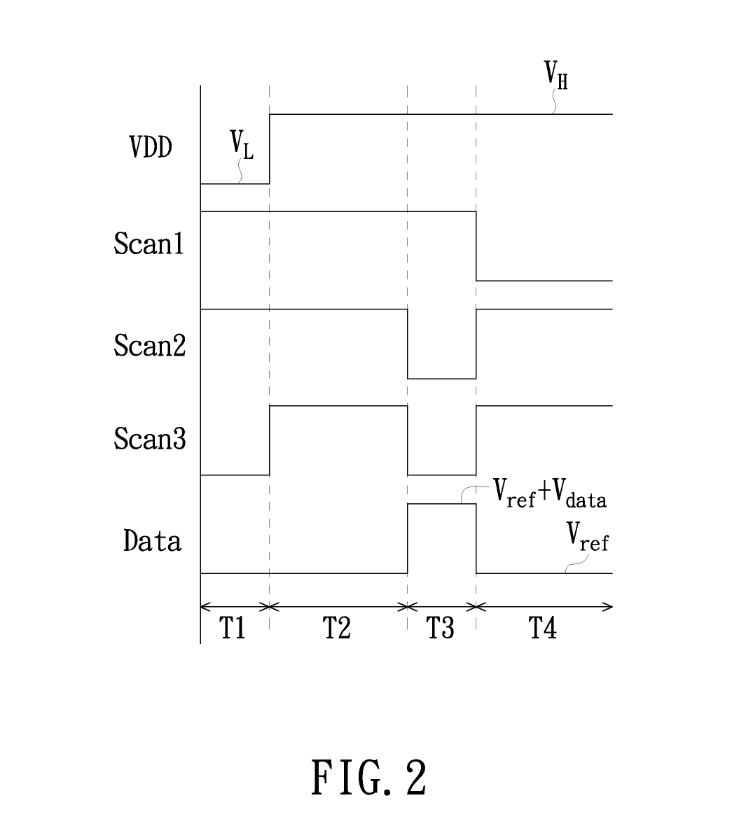

In the present embodiment, the first reference voltage level is implemented by a ground voltage level; however, the present invention is not limited thereto. Further, in the present embodiment, the first scan line, the second scan line and the third scan line are configured to deliver a first scan signal Scan1, a second scan signal Scan2 and a third scan signal Scan3, respectively, Thus, the first switch 110 is configured to be turned. either ON or OFF according to the first scan signal Scan1; the second switch 120 is configured to be turned either ON or OFF according to the second scan signal Scan2; and the third switch 130 is configured to be turned either ON or OFF according to the third scan signal Scan3. Further, in the present embodiment, the first switch 110, second switch 120 and third switch 130 are each implemented by an N-type transistor, and the pixel circuit 100 in the present embodiment can be operated according to the chronological sequence of related signals as shown in FIG. 2.

FIG. 2 is a chronological sequence of the related signals for operating the pixel circuit 100 of FIG. 1 in accordance with an embodiment of the present invention. Please refer to FIGS. 1 and 2 together. During a reset period 11 the power supply voltage VDD has a first voltage level V_{L}, that is lower than the first reference voltage level; both of the first scan signal Scan1 and the second scan signal Scan2 have a high Voltage level; the third scan signal Scan3 has a low voltage level; and the data signal Data has a second reference voltage level V_{ref}. Thus, during the reset period T1, both of the first switch 110 and the second switch 120 are turned ON and the third switch 130 is turned OFF. Accordingly, the voltage level of the first node A is V_{ref}, the voltage level of the second node B V) and the voltage level of the third node C is

$${V}_{ref} = \frac{{C}_{1}}{{C}_{1} + {C}_{2}} ,$$

where C₁ represents the capacitance of the first capacitor 150 and C₂ represents the capacitance of the second capacitor 160,

Next, during a compensation period T2, the power supply voltage VDD has a second voltage. level V_{H} that is higher than the first reference voltage level; each of the first scan signal Scan1, the second scan signal Scan2 and the third scan signal Scan3 have a high voltage level; and the data signal Data has the second reference voltage level V_{ref}. Thus, during the compensation period 12, all of the first switch 110, the second switch 120 and the third switch 130 are turned ON. Accordingly, the voltage level of the first node A is V_{ref}; the voltage level of the second node B is converted from V_{L} to V_{ref}−Vₜₕ, wherein Vₜₕ represents the threshold voltage of the N-type transistor 140; and the Voltage level of the third node C is converted from

$${V}_{ref} \times \frac{{C}_{1}}{{C}_{1} + {C}_{2}} to {V}_{ref} - {V}_{th} .$$

Next, during a data writing period T3, the power supply voltage VDD has the second voltage level V_{H}; the first scan signal Scan1 has a high voltage level; both of the second scan signal Scan2 and the third scan signal Scan3 have a low voltage level; and the data signal Data has a data voltage level V_{ref}+V_{data}, wherein V_{data} represents the value of the voltage to be written in. Thus, during the data writing period T3, the first switch 110 is turned ON and both of the second switch 120 and the third switch 130 are turned OFF. Accordingly, the voltage level of the first node A is converted from V_{ref} to V_{ref}+V_{data}; the voltage level of the second node B is V_{ref}−Vₜₕ; and the voltage level of the third node C is converted from

$${V}_{ref} - {V}_{th} to {V}_{ref} - {V}_{th} + {V}_{data} \times \frac{{C}_{1}}{{C}_{1} + {C}_{2}} .$$

Next, during a light-emitting period T4, the power supply voltage VDD has the second voltage level V_{H}; the first scan signal Scan1 has a low voltage level; both of the second scan signal Scan2 and the third scan signal Scan3 have a high voltage level; and the data signal Data has the second reference voltage level V. Thus, during the light-emitting period T4, the first switch 110 is turned OFF and both of the second switch 120 and the third switch 130 are turned ON. Accordingly, the voltage level of the first node A is converted from

$${V}_{ref} + {V}_{data} to {V}_{data} \times \frac{{C}_{2}}{{C}_{1} + {C}_{2}} + {V}_{th} + {V}_{OLED} ,$$

wherein V_{OLED} represents the crossing voltage of the organic light emitting diode 170; the voltage level of the second node B is converted from V_{ref}−Vₜₕ to V_{OLED}; and the voltage level of the third node C is converted from

$${V}_{ref} - {V}_{th} + {V}_{data} \times \frac{{C}_{1}}{{C}_{1} + {C}_{2}}$$

to V_{OLED}. Since the current I_{D} flowing through the N-type transistor 140 can be expressed as I_{D}=K(V_{GS} −Vₜₕ)² (wherein K represents the conductive parameter of the N-type transistor 140 and V_{GS} represents the voltage difference between the gate and the source of the N-type transistor 140), the current I_{D}. flowing through the N-type transistor 140 can be re-expressed as

$${I}_{D} = K ( {V}_{data} \times \frac{{C}_{2}}{{C}_{1} + {C}_{2}} )$$

by introducing the voltage levels of the first node A and the second node B into the equation I_{D}=K(V_{GS}−Vₜₕ)². According to the equation

$${I}_{D} = K ( {V}_{data} \times \frac{{C}_{2}}{{C}_{1} + {C}_{2}} ) ,$$

it is to be noted that the current flowing, through the N-type transistor 140 is independent of the threshold voltage Vₜₕ, of the N-type transistor 140 and the crossing voltage V_{OLED}, of the organic light emitting diode 170;

In summary, the first scan signal Scan1, the second scan signal Scan2 and the third scan signal Scan3 of the present embodiment are configured to have the following configurations for turning on or off the respective switches: during the reset period T1 the first scan signal Scan1 and the second scan signal Scan2 are configured to turn on the first switch 110 and the second switch 120, respectively, and the third scan signal Scan3 is configured to turn off the third switch 130; during the compensation period 12, the first scan signal Scan1, the second scan signal Scan2 and the third scan signal Scan3 are configured to turn on the first switch 110, the second switch 120 and the third switch 130, respectively; during the data writing period T3, the first scan signal Scan1 is configured to turn on the first switch 110 and the second scan signal Scan2 and the third scan signal Scan3 are configured to turn off the second switch 120 and the third switch 130, respectively; and during the light-emitting period 14, the first an signal Scan1 is configured to turn off the first switch 110 and the second scan signal Scan2 and the third scan signal Scan3 are configured to turn on the second switch 120 and the third switch 130, respectively. It is to be noted that the switches 110, 120 and 130 are each exemplarily implemented by an N-type transistor; however, the present invention is not limited thereto. In other words, the switches 110, 120 and 130 may each be implemented by a P-type transistor in another embodiment, or, one or more of the switches 110, 120 and 130 may be implemented by a P-type transistor(s) and the remaining(s) is/are implemented by an N-type transistor(s) in still another embodiment only if the aforementioned switch and signal configurations are implemented.

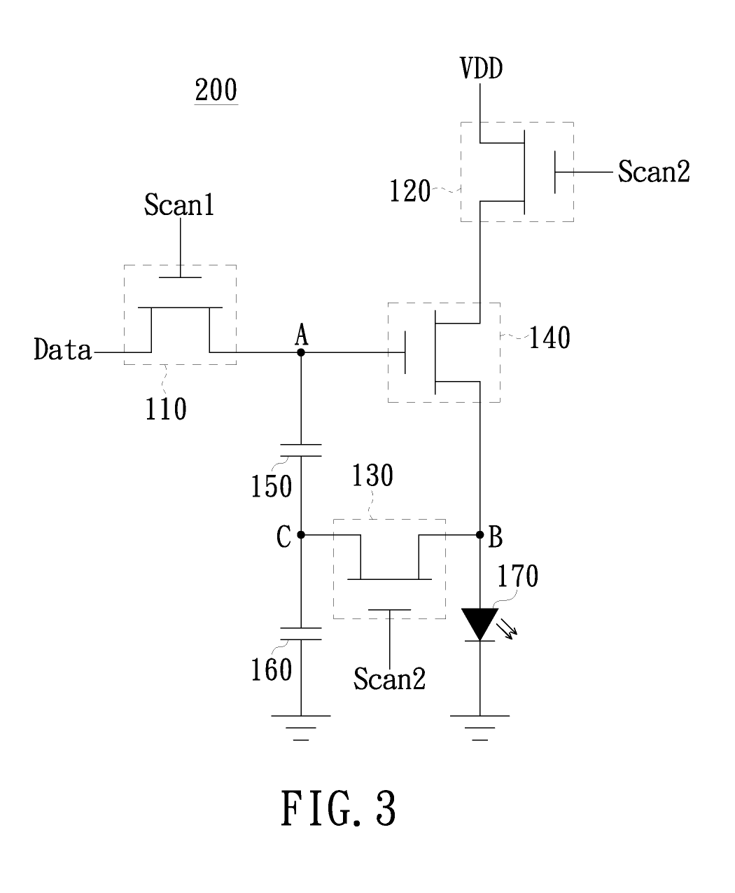

Please refer to FIG. 3, which is a schematic pixel circuit diagram in accordance with the second embodiment of the present invention. Elements or signals in the pixel circuit 200 in FIG. 3 of the present: embodiment that are identical to those shown in FIG. 1 are labeled with the same numberings for simplification. The main difference between the pixel circuit 200 in FIG. 3 and the pixel circuit 100 in FIG. 1 is that the control end of the third switch 130 is configured to receive the second scan signal Scan2 through the third scan line (not shown). Thus, the third switch 130 is configured to be turned either ON or OFF according to the second scan signal Scan2. Similarly, in the present embodiment, the first reference voltage level is implemented by a ground voltage level; however, the present invention is not limited thereto. Further, in the present embodiment, the first switch 110, second switch 120 and third switch 130 are each implemented by an N-type transistor, and the pixel circuit 200 in the present embodiment can be operated according to the chronological sequence of the related signals as shown in FIG. 2.

Please refer to FIGS. 3 and 2 together. During the reset period T1, the power supply voltage VDD has the first voltage level V_{L}; both of the first scan signal Scan1 and the second scan signal Scan2 have a high voltage level; and the data signal Data has the second reference voltage level V. Thus, during the reset period T1, all of the first switch 110, the second switch 120 and the third switch 130 are turned ON. Accordingly, the voltage level of the first node A is V_{ref} and both of the voltage levels of the second node B and the third node C are V_{L}.

Next, during the compensation period T2, the power supply voltage VDD has the second voltage level V_{H}; both of the first scan signal Scan1 and the second scan signal Scan2 have a high voltage level; and the data signal Data has the second reference voltage level V. Thus, during the compensation period T2, all of the first switch 110, the second switch 120 and the third switch 130 are turned ON. Accordingly, the voltage level of the first node A is V; the voltage level of the second node B is converted from V_{L} to V_{ref}−Vₜₕ, wherein Vₜₕ represents the threshold voltage of the N-type transistor 140; and the voltage level of the third node C is converted from V_{L} to V_{ref}−Vₜₕ.

Next, during the data writing period T3 the power supply voltage VDD has the second voltage level the first scan signal Scan1 has a high voltage level; the second scan signal Scan2 has a low voltage level; and the data signal Data has a data Voltage level V_{ref}+V_{data}, wherein V_{data} represents the value of the voltage to be written in, Thus, during the data writing period T3, the first switch 110 is turned ON and both of the second switch 120 and the third switch 130 are turned OFF. Accordingly, the voltage level of the first node A is converted from V_{ref} to V_{ref}+V_{data}; the voltage level of the second node B is V_{ref}−Vₜₕ; and the voltage level of the third node C is converted from

$${V}_{ref} - {V}_{th} to {V}_{ref} - {V}_{th} + {V}_{data} \times \frac{{C}_{1}}{{C}_{1} + {C}_{2}} ,$$

wherein C₁ represents the capacitance of the first capacitor 150 and C₂ represents the capacitance of the second capacitor 160.

Next, during the light-emitting period T4, the power supply voltage VDD has the second voltage level V_{H}; the first scan signal Scan1 has a low voltage level; the second scan signal Scan2 has a high voltage level; and the data signal Data has the second reference voltage level Thus, during the light-emitting period T4, the first switch 110 is turned OFF and both of the second switch 120 and the third switch 130 are turned ON. Accordingly, the voltage level of the first node A is converted from

$${V}_{ref} + {V}_{data} to {V}_{data} \times \frac{{C}_{2}}{{C}_{1} + {C}_{2}} + {V}_{th} + {V}_{OLED} ,$$

wherein V_{OLED} represents the crossing voltage of the organic light emitting diode 170; the voltage level of the second node B is converted from V_{ref}−Vₜₕ to V_{OLED}; and the voltage level of the third node C is converted from

$${V}_{ref} - {V}_{th} + {V}_{data} \times \frac{{C}_{1}}{{C}_{1} + {C}_{2}}$$

to V_{OLED}. Since the current I_{D} flowing through the N-type transistor 140 can be expressed as I_{D}=K(V_{GS}−Vₜₕ)² (wherein K represents the conductive parameter of the N-type transistor 140 and V_{GS} represents the voltage difference between the gate and the source of the N-type transistor 140), the current I_{D} flowing through the N-type transistor 140 can be re-expressed as

$${I}_{D} = K ( {V}_{data} \times \frac{{C}_{2}}{{C}_{1} + {C}_{2}} )$$

by introducing the voltage levels of the first node A and the second node B into the equation I_{D}=K(V_{GS}−Vₜₕ)². According to the equation

$${I}_{D} = K ( {V}_{data} \times \frac{{C}_{2}}{{C}_{1} + {C}_{2}} ) ,$$

it is to be noted that the current flowing through the N-type transistor 140 is independent of the threshold voltage Vₜₕ of the N-type transistor 140 and the. crossing voltage V_{OLED} of the organic light emitting diode 170.

In summary, the first scan signal Scan1, the second scan signal Scan2 and the third scan signal Scan3 in the present embodiment are configured to have the following configurations for turning on or off the respective switches: during the reset period T1, the first scan signal Scan1 is configured to turn on the first switch 110 and the second scan signal Scan2 is configured to turn on the second switch 120 and the third switch 130; during the compensation period T2, the first scan signal Scan1 is configured to turn on the first switch 110 and the second scan signal Scan2 is configured to turn on the second switch 120 and the third switch 130; during the data writing period T3, the first scan signal Scan1 is configured to turn on the first switch 110 and the second scan signal Scan2 is configured to turn off the second switch 120 and the third switch 130; and during, the light-emitting period T4, the first scan signal Scan1 is configured to turn off the first switch 110 and the second scan signal Scan2 is configured to turn on the second switch 120 and the third switch 130. It is to be noted that the switches 110, 120 and 130 are each exemplarily implemented by an N-type transistor; however, the present invention is not limited thereto, in other words, the switches 110, 120 and 130 may each be implemented by a P-type transistor in another embodiment, or, one or more of the switches 110, 120 and 130 may be implemented by a P-type transistor(s) and the remaining(s) is/are implemented by an N-type transistor(s) in still another embodiment only if the aforementioned switch and signed configurations are implemented.

In sum, by configuring the first switch, the second switch and the third switch to be turned ON or OFF during the reset period, the compensation period, the data writing period T3 and the light-emitting period, respectively, the current flowing through the N-type transistor is independent of the threshold voltage of the N-type transistor and the crossing voltage of the organic light emitting diode in the pixel circuit of the present invention; and consequently, the compensation effect is achieved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A pixel circuit, comprising:
a first switch, having a first control end, a first end and a second end, the first switch is configured to have the first control end electrically coupled to a first scan line and the first end for receiving a data signal;
a second switch, having a second control end, a third end and a fourth end, the second switch is configured to have the second control end electrically coupled to a second scan line and the third end for receiving a power supply voltage;
an N-type transistor, having a third control end, a fifth end and a sixth end, the N-type transistor is configured to have the third control end electrically coupled to the second end and the fifth end electrically coupled to the fourth end;
a third switch, having a fourth control end, a seventh end and an eighth end, the third switch is configured to have the fourth control end electrically coupled to a third scan line and the eighth end electrically coupled to the sixth end;
an organic light emitting diode, having an anode and a cathode, the organic light emitting diode is configured to have the anode electrically coupled to the eighth end and the cathode electrically coupled to a first reference voltage level;
a first capacitor, electrically coupled between the second end and the seventh end; and
a second capacitor, electrically coupled between the seventh end and the first reference voltage level.

2. The pixel circuit according to claim 1, wherein the first scan line, the second scan line and the third scan line are configured to deliver a first scan signal, a second scan signal and a third scan signal, respectively.

3. The pixel circuit according to claim 2, wherein during a reset period, the power supply voltage has a first voltage level, the first scan signal and the second scan signal are configured to turn on the first switch and the second switch respectively, the third scan signal is configured to turn off the third switch, and the data signal has a second reference voltage level; during a compensation period, the power supply voltage has a second voltage level, the first scan signal, the second scan signal and the third scan signal are configured to turn on the first switch, the second switch and the third switch respectively, and the data signal has the second reference voltage level; during a data writing period, the power supply voltage has the second voltage level, the first scan signal is configured to turn on the first switch, the second scan signal and the third scan signal are configured to turn off the second switch and the third switch respectively, and the data signal has a data voltage level; during a light-emitting period, the power supply voltage has the second voltage level, the first scan signal is configured to turn off the first switch, the second scan signal and the third scan signal are configured to turn on the second switch and the third switch respectively, and the data signal has the second reference voltage level,
wherein the reset period occurs prior to the compensation period, the compensation period occurs prior to the data writing period, and the data writing period occurs prior to the light-emitting period,
wherein the first voltage level is lower than the first reference voltage the second voltage level is higher than the first reference voltage level, and the data voltage level is higher than the second reference voltage level.

4. The pixel circuit according to claim 3, wherein the first switch, the second switch and the third switch are each implemented by an N-type transistor.

5. The pixel circuit according to claim 4, wherein during the reset period, both of the first scan signal and the second scan, signal have a high voltage level and the third scan signal has a low voltage level; during the compensation period, all of the first scan signal, the second scan signal and the third scan signal have a high voltage level; during the data writing, period, the first scan signal has a high voltage level and both of the second scan signal and the third scan signal have. a low voltage level; and during the light-emitting period, the first scan signal has a tow voltage level and both of the second scan signal and the third scan signal have a high voltage level.

6. The pixel circuit according to claim 1, wherein the first scan line is configured to deliver a first scan signal and both of the second scan line and the third scan line are configured to deliver a second scan signal.

7. The pixel circuit according to claim 6, wherein during a reset period, the power supply voltage has a first voltage level, the first scan signal is configured to turn on the first switch, the second scan signal is configured to turn on the second switch and the third switch, and the data signal. has a second reference voltage level; during a compensation period, the power supply voltage has a second voltage level, the first scan signal is configured to turn on the first switch, the second scan signal is configured to turn on the second switch and the third switch, and the data signal has the second reference voltage level; during a data writing period, the power supply voltage has the second voltage level, the first scan signal is configured to turn on the first switch, the second scan signal is configured to turn off the second switch and the third switch, and the data signal has a data voltage level; during a light-emitting period, the power supply voltage has the second voltage level, the first scan signal is configured to turn off the first switch, the second scan signal is configured to turn on the second switch and the third switch, and the data signal has the second reference voltage level,
wherein the reset period occurs prior to the compensation period, the compensation period, occurs prior to the data writing period, and the data writing period occurs prior to the light-emitting period,
wherein the first voltage level is lower than the first reference voltage level, the second voltage level is higher than the first reference voltage level, and the data voltage level is higher than the second reference voltage level.

8. The pixel circuit according to claim 7, wherein the first switch, the second switch and the third switch are each implemented by an N-type transistor.

9. The pixel circuit according to claim 8, wherein during the reset period, both of the first scan signal and the second scan signal have a high voltage level; during the compensation period, both of the first scan signal and the second scan signal have a high voltage level; during the data writing period, the first scan signal has a high voltage level and the second scan signal has a low voltage level; and during the light-emitting period, the first scan signal has a low voltage level and the second scan signal has a high voltage level.
